(19) United States
(12) Patent Application Publication
(10) Pub. No.: US 2004/0054429 A1
(43) Pub. Date: Mar. 18, 2004

(54) Control system having abnormality monitor function

(76) Inventors: Masakazu Doi, Obu-City (JP); Tomohisa Kishigami, Obu-City (JP); Hajime Kikkawa, Nagoya-City (JP)

Correspondence Address: POSZ & BETHARDS, PLC, 11250 ROGER BACON DRIVE, SUITE 10, RESTON, VA, 20190, US

(21) Appl. No.: 10/653,075

(22) Filed: Sep. 3, 2003

(30) Foreign Application Priority Data
Sep. 12, 2002 (JP) 2002-267050

(51) Int. Cl. G05B 9/02

(52) U.S. Cl. 700/79

(57) ABSTRACT

A signal unit sends signal data to a computation unit and a monitor unit. The computation unit computes using the signal data sent by the signal unit, signal data sent by other than the signal unit, or internal control data to send operation data to an output unit and the monitor unit. The monitor unit then determines whether abnormality is present, by comparing the received signal data and the received operation data. For instance, there is a case where the operation data indicates that a switch of a door lock is in an ON state although the signal data indicates that the switch of the door lock is in an OFF state. In the case, it is assumed that abnormality between the signal unit and the computation unit or abnormality within the computation unit may be present.

### CROSS REFERENCE TO RELATED APPLICATIONS

This application is based on and incorporates herein by reference Japanese Patent Application No. 2002-267050 filed on Sep. 12, 2002.

### FIELD OF THE INVENTION

The present invention relates to a control system where a signal processing unit and a computation processing unit are connected through a data bus, and especially to the control system that has abnormality monitor function.

### BACKGROUND OF THE INVENTION

Multiplex communications systems are recently formed, for instance, in an automotive. Of the multiplex communications systems a control system connects a signal processing unit, a computation processing unit, and an output processing unit to enable them to communicate data one another. Here, the signal processing unit sends a switch state or a sensor detection result as signal data. The computation processing unit computes based on the signal data sent by the signal processing unit, signal data sent by other than the signal processing unit, or internal control data to thereby send operation command data. The output processing unit activates, based on the received operation command data, an actuator or a load. This control system further includes a monitor processing unit for monitoring abnormality of the system. The monitor processing unit can detect and store the abnormality of the system for analyzing malfunction of the system or troubleshooting.

For instance, JP-B2-2980709 discloses a system including a single monitor processing unit that has the same input computation function as each of a plurality of computation processing units. Here, abnormality diagnosis for each computation processing is executed by comparing a computation result of each computation processing unit with that of the monitor processing unit.

Furthermore, for instance, JP-A-S60-35901 discloses a system including a function that stores, when abnormality occurs in an information sending unit of a vehicle, information around the time when the abnormality occurs. Here, the information includes an operation command for a control target device and an operating state of the control target device. The stored information is thereafter outputted when the vehicle returns to a garage. In the system, a detection method takes place as follows: a central station sends an operation command for a control target device to a terminal; after receiving it, the terminal activates the control target device while it sends operation information of the control target device to the central station; and an information monitor unit monitors the operation information of the control device that is sent to the central station to detect abnormality of the information.

As a system becomes highly functional, a vehicle is connected with tens of computation processing units, of which relating units are different depending on the respective functions. For instance, although a vehicle-speed door-lock and a driver-seat centralized door-lock functions relate to a door lock motor, each function uses different units. A user's claim regarding a malfunction results from inconsistency between an actual state and a function that the user expects. It means that a cause of the claim results from one of three cases. The first case is an abnormal operation that can be found by self-diagnosis. The second is an abnormal operation that cannot be found by the self-diagnosis. The third is user's mismanipulating or misunderstanding that is a normal operation for the system.

For instance, when a user's claim of “doors are automatically locked without any user's intention” is informed, it is not known which function executed locking the doors. Any related control devices cannot be picked up. Even if it is known that which function executed locking the doors, it cannot be known that which computation processing unit is causative.

Under this situation, using above conventional monitoring technologies exhibits a problem. For instance, when abnormality diagnosis for a present vehicle is executed by using the monitor processing unit in JP-B2-2980709, computation function corresponding to the tens of computation processing units must be installed in the single monitor processing-unit. The computation processing units are respectively developed by plural component manufacturers, so that it is very difficult to install the computation function corresponding to the tens of units to the single monitor processing unit. Vast memory is necessary for software having the computation function corresponding to the tens of units, so that a microcomputer for handling the software becomes expensive. Further, re-designing one of the computation processing units is followed by re-designing the monitor processing unit, which results in lessening maintenance efficiency of the system.

In above-mentioned JP-A-S60-35901, what the central station sends is only an operation command to the control target device. Further, on the assumption that the control target device in the terminal normally operates, the information monitor unit determines whether abnormality is present by monitoring the information sent to the central station. In this structure, when a signal unit, a computation unit, and an output unit exist as nodes within a network, objects for determining are limited to relation between the computation unit and the output unit. On the other hand, when considering relation between the signal unit and the computation unit, it is not known how the signal information sent by the signal unit is processed by the computation unit. Therefore, using the above conventional technologies does not lead to properly determining presence or absence of abnormality in the system.

### SUMMARY OF THE INVENTION

It is an object of the present invention to enable a monitor processing unit to determine abnormality between a signal processing unit and a computation processing unit without grasping contents of computation function of the computation processing unit.

To achieve the above object, a control system is provided with the following. A signal processing unit sends, to a computation processing unit and a monitor processing unit, signal data that indicates a state of a switch or a detection result of a sensor. The computation processing unit executes a computation using the signal data sent by the signal processing unit or other, or internal data, and then sends operation command data to an output processing unit and operation condition data to the monitor processing unit. Here, the operation command data controls the output processing unit for activating at least one of an actuator and a load, while the operation condition data indicates that condition where an operation command trigger that activates an operation command target is effected. The monitor processing unit receives the operation condition data and stores it. The monitor processing unit determines whether abnormality is present, by comparing the stored signal data with the operation condition data received from the computation processing unit. This structure enables the monitor processing unit to determine abnormality between the signal processing unit and the computation processing unit without necessity of grasping contents of computation function of the computation processing unit.

For instance, in a door-lock system, a signal processing unit detects a state of a door-lock switch, while an output processing unit activates a door-lock motor. The monitor processing unit receives from the signal processing unit signal data indicating the door-lock switch shifts from an OFF state to an ON state. The monitor processing unit receives operation data including data indicating that the door-lock switch is in an ON state. In the case, information that the door-lock switch is on the ON state is commonly found in the signal data from the signal processing unit and the operation data from the computation processing unit. The monitor processing unit thereby determines that the door-lock normally functioned.

By contrast, the monitor processing unit receives from the signal processing unit signal data indicating the door-lock switch shifts from an ON state to OFF state. The monitor processing unit receives operation data including data indicating that the door-lock switch is in an ON state. In the case, information regarding the state of the door-lock switch is inconsistent between the signal data and the operation data. This leads to indicating possibility of abnormality between the signal processing unit and the computation processing unit or abnormality within the computation processing unit itself.

For instance, in a case where the abnormality determination result is stored somewhere, when a user claims that the door-lock automatically functions without any user's intension, the stored determination result enables analysis for the claimed item to be easily executed.

### BRIEF DESCRIPTION OF THE DRAWINGS

The above and other objects, features, and advantages of the present invention will become more apparent from the following detailed description made with reference to the accompanying drawings. In the drawings:

FIG. 1A is a schematic block diagram showing structure of a control system according to an embodiment of the present invention;

FIG. 1B is a diagram showing applied instances in a door-lock control system according to the embodiment;

FIGS. 2A to 2C are diagrams showing contents of data in a signal device;

FIGS. 3A to 3C are diagram showing contents of data in a computation device;

FIGS. 4A to 4C are diagram showing contents of data in an output device;

FIG. 5A is a timing chart diagram explaining operations among the signal device, the computation device, and a monitor device;

FIG. 5B is a flow chart diagram explaining operations of the monitor device; and

FIGS. 6A to 6C, 7A to 7C are schematic block diagrams showing structures of control systems according to other embodiments of the present invention.

### DETAILED DESCRIPTION OF THE PREFERRED EMBODIMENTS

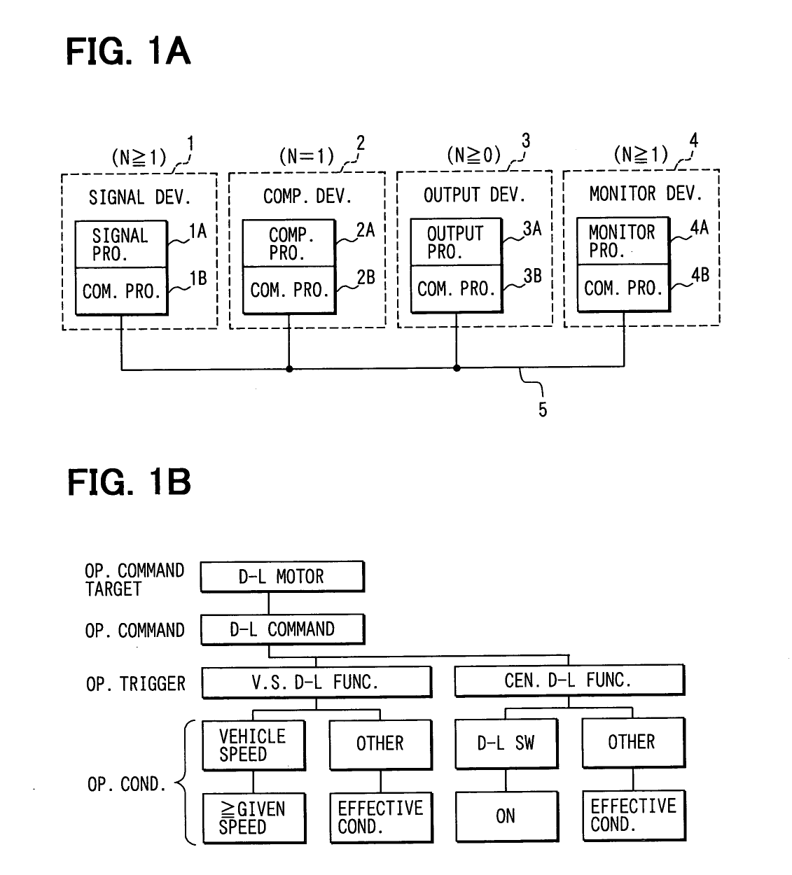

The present invention is directed to a vehicular control system. Structure of the system according to an embodiment of the present invention is shown in FIG. 1A. The control system includes a signal device 1, a computation device 2, an output device 3, and a monitor device 4, each of which has a multiplex communications function and communicates data with one another through a communications bus 5.

The signal device 1 includes a signal processing unit 1A and a communications unit 1B. It further includes switches (not shown) and sensors (not shown) and is capable of sending to the communications bus 5 states of the switches, e.g., ON/OFF states of a door-lock switch, and detection results of the sensor, e.g., vehicle speed. The control system includes only one signal device 1 in FIG. 1, but it can includes more than one signal device 1.

The computation device 2 includes a computation processing unit 2A and a communication processing unit 2B. The computation device 2 executes given computation using signal data sent by the signal device 1 or other, internal control data or the like. It then thereby sends operation command data for activating a given function in the output device 3. The control system includes only one computation device 2. It means that the control system conceptually includes one computation device 2. For instance, in a distributed control system including apparent plural computation devices 2, when we focus attention on a given computation device 2, the other computation devices 2 are treated as signal devices 1.

The output device 3 includes an output processing unit 3A and a communication processing unit 3B. The output device 3 further includes an actuator or the like, and activates the actuators or loads, e.g., door-lock motor, based on the operation command data sent by the computation device 2. Although this control system includes the output device 3, an output device can be disposed in an external system or the like. Here, the operation command data can be externally sent by the computation device 2 to the external output device. Therefore, the control system can include no output device 3, or one or more output devices 3.

When the computation device 2 sends the operation command data to the output device 3, it additionally sends operation trigger data and operation condition data. Here, the operation trigger data indicates a trigger for the operation command data that activates an operation command target, while the operation condition data indicates that a condition where the trigger indicated in the operation trigger data is effected. Hereafter, the operation command data, operation trigger data, and operation condition data are generally called operation data.

The monitor device 4 includes a monitor processing unit 4A and a communication processing unit 4B. The monitor device 4 receives the signal data sent by the signal device 1 to store the signal data in a memory (not shown). It further determines presence/absence of abnormality by comparing the stored signal data with the operation data received from the computation device 2. Although this control system includes only one monitor device 4 in FIG. 1A, it can include more than one monitor device 4. When more than one monitor device 4 are included, reliability of a determination result can be enhanced.

The communication processing units in the devices 1 to 4 can be combined as a common communication processing unit, as described later. “This control system can includes more than one signal device 1 or more than one monitor device 4” or “the control system includes only one computation device 2” does not necessarily mean that the same number of the communication processing units are included in the referred devices. Each device 1 to 4 does not necessarily include a communication processing unit as a unit. For instance, the signal device 1 must include a signal processing unit as a primary processing unit, but can include no communication processing unit.

Each of the communication processing units 1A, 2A, 3A, 4A is disposed between the communications bus 5 and each of the signal processing unit 1A, computation processing unit 2A, output processing unit 3A, and monitor processing unit 4A, to thereby relay various data among them.

Operations and data of a door-lock control system as applied instances are explained in FIG. 1B. Triggers for a door-lock command include a vehicle-speed door-lock function and a centralized door-lock function. The vehicle-speed door-lock function is effected under a condition where a vehicle speed exceeds a given speed or other conditions if existing. The centralized door-lock function is effected under a condition where a door-lock switch is turned on (shifted to an ON state), or other conditions if existing.

Information that should be grasped from the operation condition data is not which operation trigger is effected, but under which condition among several conditions the operation trigger is finally effected. In detail, it is not important that which operation trigger, the vehicle-speed door-lock function or the centralized door-lock function, generates a door-lock command, but it is important that under which condition the door-lock function is finally effected. Abnormality determination can be executed by additional considering added information that is which operation trigger, the vehicle-speed door-lock function or the centralized door-lock function, generates the door-lock command.

Here, words and detailed instances will be summarized as follows.

(i) Operation command target: door-lock motor

(ii) Operation command: door-lock command

(iii) Operation trigger: vehicle-speed door-lock function, centralized door-lock function

(iv) Operation condition: where vehicle speed exceeds given speed, where door-lock switch is in an ON state

Detailed instances of processing data in the signal device 1, computation device 2, and output device 3 will be explained.

### (1) Data Processing in Signal Device 1

(1-1)

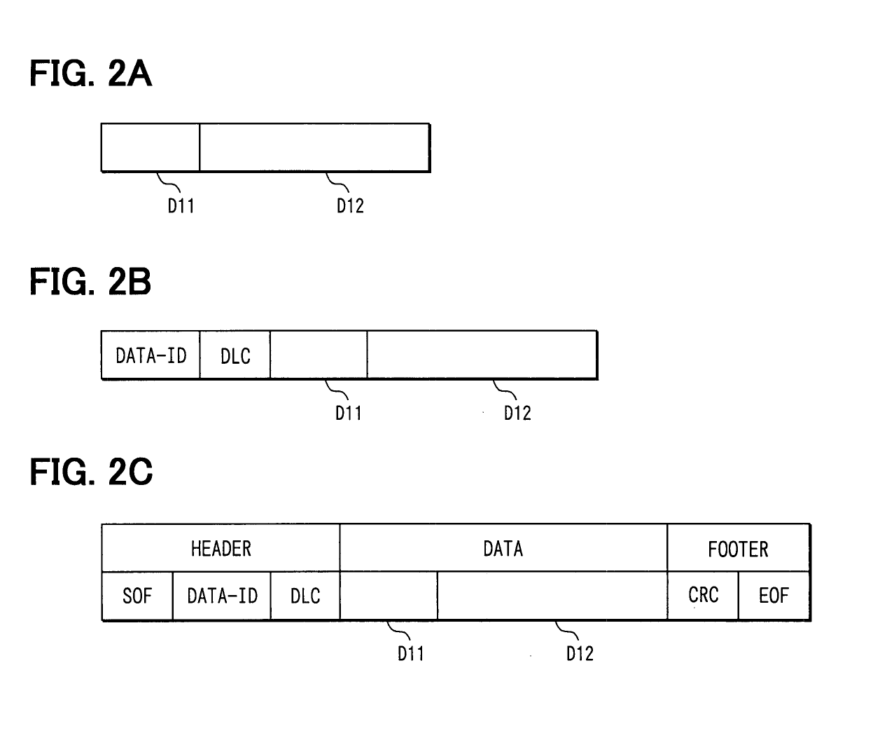

FIG. 2A shows an instance of contents of data that the signal processing unit 1A of the signal device 1 generates. The data includes signal data D11 and sending-timing specifying information D12. The data is generated based on an input from sensors. The sending-timing specifying information D12 can be generated by the communication processing unit 1B instead of the signal processing unit 1A.

(i) The signal data D11 includes as follows:

State signals such as ON/OFF or detection value of sensors

State-shifting signals such as OFF→ON, or ON→OFF

(ii) The sending-timing specifying information D12 includes as follows.

Information with prior/posterior relationship: counter value (one counter value provided for one signal device 1 or one data ID is incremented or decremented every sending timing)

Information without prior/posterior relationship: random number that is not repeatedly present during a given period (one random number provided for one signal device 1 or one data ID is changed at sending timing) or a number calculated using a given mathematic function

Sending-time information (absolute time or relative time, time common among the devices or time dedicated to each device)

Number specifying signal data during a given period (either of with or without prior/posterior relationship)

information that changes only when a content of the signal data is changed

(1-2)

FIG. 2B shows an instance of contents of data (data unit) that the signal processing unit 1A generates and stores in a memory within the communication processing unit 1B. The data includes a data ID (DATA-ID) indicating a kind of sending data and a data length code (DLC) indicating a data length, in advance of the signal data D11 and sending-timing specifying information D12 shown in FIG. 2A. Here, the signal data D11 and the sending-timing specifying information D12 can be expressed with being combined with a part of the DATA-ID or the entire DATA-ID.

(1-3)

FIG. 2C shows an instance of contents of data (data frame) that the communication processing unit 1B generates and sends to the communications bus 5. The data is used in Controller Area Network (CAN). The data is formed of a header region, a data region, and a footer region. The header region includes a start-of-frame (SOF) that indicates a start of the frame in advance of the above DATA-ID and DLC. The data region includes the above-mentioned data signal D11 and sending-timing specifying information D12. The footer region includes a cyclic redundant check (CRC) and an end-of-frame that indicates an end of the frame.

### (2) Data Processing in Computation Device 2

(2-1)

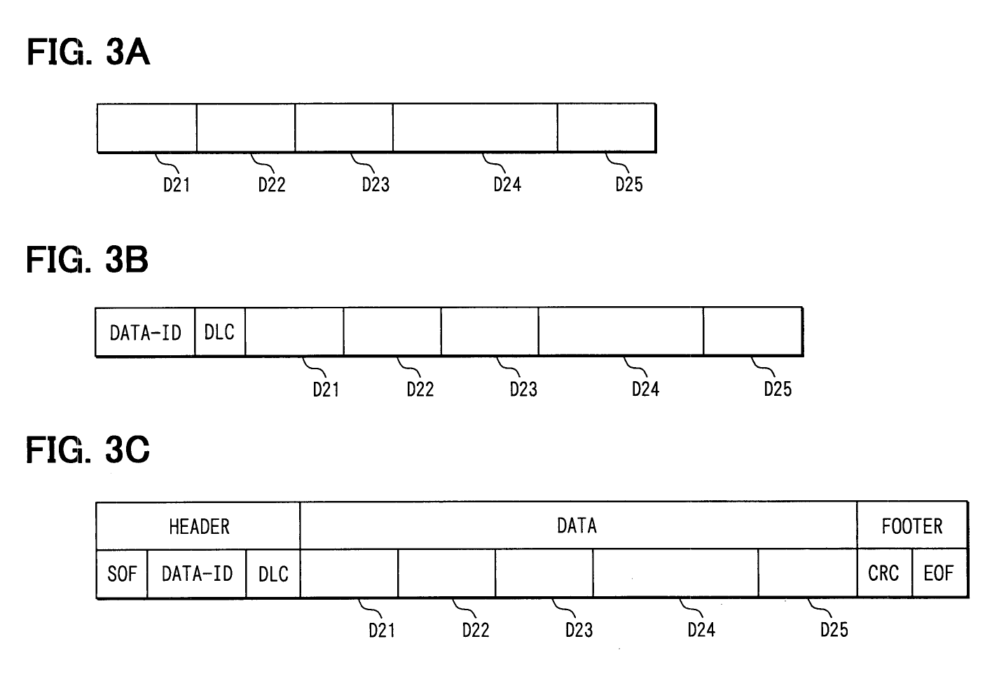

FIG. 3A shows an instance of contents of data that the computation processing unit 2A generates. The data includes operation command data D21, operation condition data D22, operation trigger data D23, operation-command-timing specifying information D24, and signal-data specifying information D25. The operation-command-timing specifying information D24 can be generated by the communication processing unit 2B instead of the computation processing unit 2A.

(i) The operation command data D21 includes as follows:

Operation command of “lock” or “unlock”

Operation continuing command of “continue a state of locking” or “continue a state of unlocking”

(ii) The operation condition data D22 includes as follows.

Equivalents to signal data D11 such as data indicating that a door-lock switch is in an ON state, data indicating that an effective condition that a vehicle speed exceeds a given speed (a final effective condition when plural conditions exist) or the like)

(iii) The operation trigger data D23 includes as follows.

Kinds of control systems relating to the operation command target (e.g., vehicle-speed door-lock system, door-lock switch system)

(iv) The operation-command-timing specifying information D24

Counter value (one counter value provided for one computation device 2 or one data ID is incremented or decremented every sending timing)

Random number that is not repeatedly present (one random number provided for one communication device 2 or one data ID is changed at sending timing) or a number calculated using a given mathematic function

Sending-time information (absolute time or relative time, time common among the devices or time dedicated to each device)

Number that is calculated using a given mathematic function and not repeatedly present during a given period

Number specifying the signal data D11 during a given period (either of with or without prior-posterior relationship)

information that changes only when a content of the signal data D11 is changed

(v) The signal-data specifying information D25 includes as follows.

Sending-timing specifying information D12 that is added to the signal data D11 for effecting a function of the operation command target

Information that is generated based on the sending-timing specifying information D12 and that specifies the signal data D11 stored in the monitor device 4

Other information that specifies the signal data D11 stored in the monitor device 4

(2-2)

FIG. 3B shows an instance of contents of data (data unit) that the computation processing unit 2A generates and stores in a memory within the communication processing unit 2B. The data includes a data ID (DATA-ID) indicating a kind of sending data and a data length code (DLC) indicating a data length in advance of the operation command data D21, operation condition data D22, operation trigger data D23, operation-command-timing specifying information D24, and signal-data specifying information D25 shown in FIG. 3A. Here, the operation command data D21, operation condition data D22, operation trigger data D23, operation-command-timing specifying information D24, and signal-data specifying information D25 can be expressed with being combined with a part of the DATA-ID or the entire DATA-ID. The operation condition data D22 must be included, while the operation trigger data D23, the operation-command-timing specifying information D24, or the signal-data specifying information D25 cannot be included. The operation command data D21 is necessary for the output device 3, while it is optional for the monitor device 4.

(2-3)

FIG. 3C shows an instance of contents of data (data frame) that the communication processing unit 2B generates and sends to the communications bus 5. The data is used in CAN. The data is formed of a header region, a data region, and a footer region. The header region includes a start-of-frame (SOF) that indicates a start of the frame in advance of the above DATA-ID and DLC. The data region includes the above-mentioned operation command data D21, operation condition data D22, operation trigger data D23, operation-command-timing specifying information D24, and signal-data specifying information D25. The footer region includes a cyclic redundant check (CRC) and an end-of-frame that indicates an end of the frame.

### (3) Data Processing in Output Device 3

(3-1)

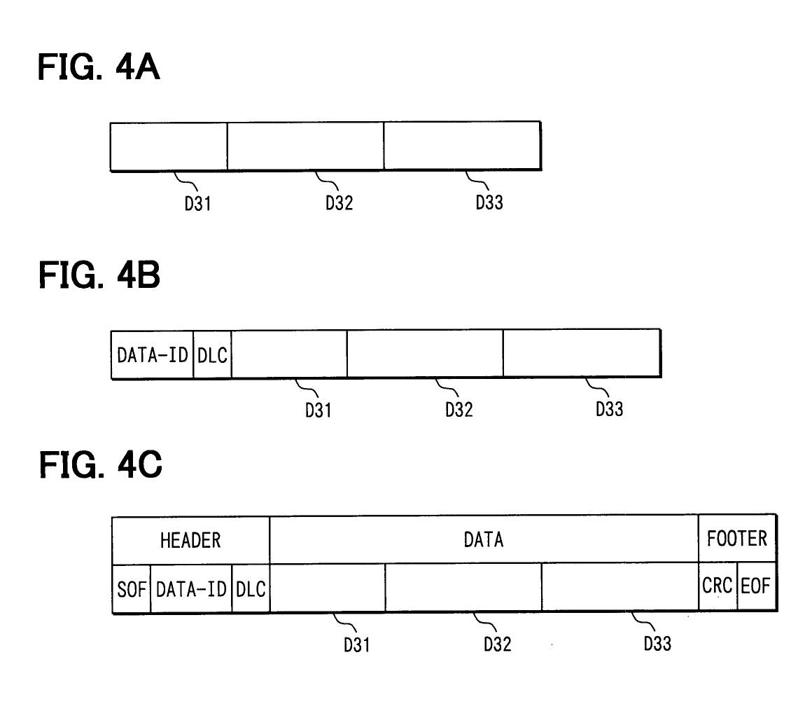

FIG. 4A shows an instance of contents of data that the output processing unit 3A generates. The data includes output data D31, operation-command-data specifying information D32, and output-timing specifying information D33. The output-timing specifying information D33 can be generated by the communication processing unit 3B instead of the output processing unit 3A.

(i) The output data D31 includes as follows:

Data indicating that the operation command data D21 is received

Data indicating that whether an actuator or a load is activated based on the operation command data D21

Data indicating whether an actuator or a load was actually activated based on the operation command data D21

(ii) The output-timing specifying information D32 includes as follows.

Counter value (one counter value provided for one output device 3 or one data ID is incremented or decremented every sending timing)

Random number that is not repeatedly present (one random number provided for one output device 3 or one data ID is changed at sending timing) or a number calculated using a given mathematic function

Sending-time information (absolute time or relative time, time common among the devices or time dedicated to each device)

Number that is calculated using a given mathematic function and not repeatedly present during a given period

Number specifying the signal data during a given period (either of with or without prior-posterior relationship)

information that changes only when a content of the signal data is changed

(iii) The operation-command-data specifying information D33 includes as follows.

Operation-command-timing specifying information D24 that is added to the operation command data D21

Information that is generated based on the operation-command-timing specifying information D24 and that specifies the operation command data D21 stored in the monitor device 4

Another information that specifies the operation command data D21 stored in the monitor device 4

(3-2)

FIG. 4B shows an instance of contents of data (data unit) that the output processing unit 3A generates and stores in a memory within the communication processing unit 3B. The data includes a data ID (DATA-ID) indicating a kind of sending data and a data length code (DLC) indicating a data length in advance of the output data D31, operation-command-data specifying information D32, and output-timing specifying information D33 shown in FIG. 4A. Here, the operation-command-data specifying information D32 or output-timing specifying information D33 can be expressed with being combined with a part of the DATA-ID or the entire DATA-ID.

(3-3)

FIG. 4C shows an instance of contents of data (data frame) that the communication processing unit 3B generates and sends to the communications bus 5. The data is used in CAN. The data is formed of a header region, a data region, and a footer region. The header region includes a start-of-frame (SOF) that indicates a start of the frame in advance of the above DATA-ID and DLC. The data region includes the above-mentioned output data D31, operation-command-data specifying information D32, and output-timing specifying information D33. The footer region includes a cyclic redundant check (CRC) and an end-of-frame that indicates an end of the frame.

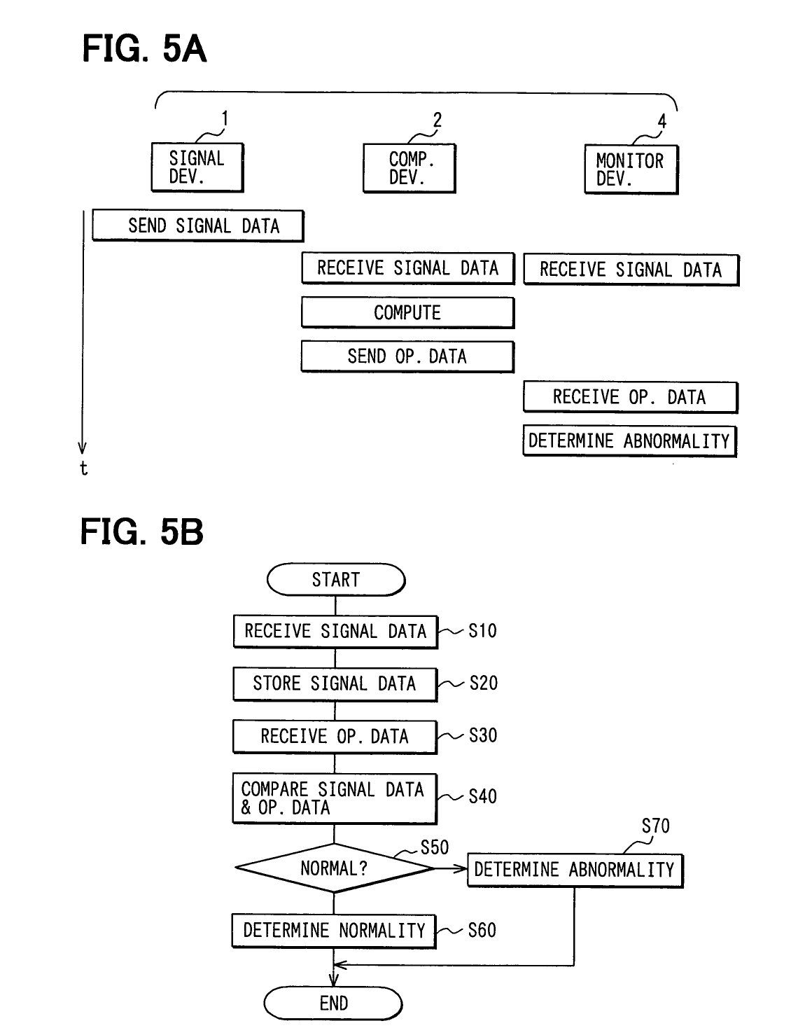

In the next place, operations of the monitor device 4 for monitoring abnormality of the system will be explained. FIG. 5A shows a timing chart of schematic operation of the signal device 1, the computation device 2, and the monitor device 4.

As the signal device 1 sends signal data, the computation device 2 receives the signal data. The computation device 2 executes given computation using the signal data received from the signal device 1, signal data received from other than the signal device 1, internal control data, or the like. The computation device 2 then sends to the output device 3 operation data, which is received also by the monitor device 4. The monitor device 4 thereafter determines whether abnormality is present.

A flow chart shown in FIG. 5B explains processing of determining presence/absence of abnormality by the monitor device 4.

At Step 10, the monitor device 4 receives the signal data sent by the signal device 1. At Step 20, the device 4 stores the received signal data in its memory 4A. At Step 30, the device 4 thereafter receives operation data sent by the computation device 2. At Step 40, the device 4 compares the received operation data with the stored signal data. At Step 50, the device 4 determines whether system is normal or abnormal. In detail, the device 4 determines it by comparing operation condition data (D22 in FIGS. 3A to 3C) in the received operation data with the stored signal data. Here, the device 4 determines it with considering sending-timing specifying information D12 (see FIGS. 2A to 2C). Namely, when the signal data D11 is repeatedly sent, the sending-timing specifying information D12 is used for determining which data should be compared.

For instance, it is assumed that the signal device 1 sends signal data D11 indicating that a door-lock switch shifts from an OFF state to an ON state. The monitor device 4 then receives and stores in its memory the signal data D11 along with the sending-timing specifying information D12 corresponding to the signal data D11. Thereafter, when the monitor device 4 receives, from the computation device 2, the operation condition data D22 that includes data indicating that the door-lock switch shifts to an ON state, that the door-lock switch shifts to the ON state is confirmed commonly in both the signal data D11 and the operation condition data D22. The monitor device 4 thereby determines that door-lock control normally functions. Consequently, at Step 60 this case is determined to be normal. In detail, a determination result of normality that the door-lock switch shifts to the ON state and door-lock is thereby executed is stored, for instance, in a nonvolatile internal memory or the like. Here, the sending-timing specifying information D12 is also stored along with the signal data D11.

Furthermore, for instance, it is assumed that the signal device 1 sends signal data D11 indicating a vehicle speed. The monitor device 4 then receives and stores in its memory the signal data D11 along with the sending-timing specifying information D12 corresponding to the signal data D11. Thereafter, the monitor device 4 receives, from the computation device 2, operation condition data D22 including data that indicates an effective condition that a vehicle speed exceeds a given speed enabling execution of the door-lock. The monitor device 4 determines whether the stored vehicle speed actually exceeds the given speed. When the vehicle speed exceeds the given speed, it is determined that normal door-lock control functions to lock doors. Consequently, at Step 60 this case is determined to be normal. In detail, a determination result of normality that the vehicle speed exceeds the given speed enabling execution of the door-lock is stored, for instance, in the nonvolatile internal memory or the like. Here, the sending-timing specifying information D12 is also stored along with the signal data D11.

Thus, the above stored determination result can be analyzed when a user claims that door-lock was executed without any user's intention. It is judged, through the analysis, that the execution of the door-lock is under normal condition and the user's claim may result from his misunderstanding. For instance, the user may mistakenly turn on the door-lock, or he may be unconscious of turning on the door-lock switch. He may not know the system where the door-lock is automatically executed when the vehicle speed exceeds the given speed. In any cases, knowing which operation condition was effective leads to easy analyzing of the execution of the function. Here, as the above cases where plural operation triggers, i.e., door-lock switch and vehicle speed, are present, the effected operation trigger is specified with the operation trigger data D23 within the operation data. The operation condition is then compared.

By contrast, for instance, it is assumed that the signal device 1 sends signal data D11 indicating that a door-lock switch shifts from an ON state to an OFF state. The monitor device 4 then receives and stores in its memory the signal data D11. Thereafter, when the monitor device 4 receives, from the computation device 2, the operation condition data D22 that includes data indicating that door-lock switch shifts to an ON state, it is judged that the door-lock was executed although the door-lock switch does not shift to the ON state. In this case, it is assumed that abnormality is present between the signal device 1 and the computation device 2 or in the computation device itself 2. Consequently, at Step 70 this case is determined to be abnormal. In detail, a determination result of abnormality that the door-lock is executed without the door-lock switch shifting to the ON state and the vehicle speed exceeding the given speed is stored in the nonvolatile internal memory or the like. For instance, when a user claims that the door-lock is automatically executed without any user's intention, response to the claim can be shortly executed by consulting the stored determination result.

The monitor device 4 executes, in determining whether abnormality is present, one or more procedures included in the following.

(i) Abnormality presence/absence is determined by comparing signal data D11 (see FIGS. 2A to 2C) with operation condition data D22 (see FIGS. 3A to 3C).

(ii) Abnormality presence/absence is determined by additionally considering operation trigger data D23 (see FIGS. 3A to 3C) in addition to the procedure (i).

(iii) Abnormality presence/absence is determined by additionally considering sending-timing specifying information D12 (see FIGS. 2A to 2C) in addition to the procedure (i) or (ii).

(iv) Abnormality presence/absence is determined by additionally considering operation-command-timing specifying information D24 (see FIGS. 3A to 3C) in addition to the procedure (i), (ii) or (iii).

(v) Abnormality presence/absence is determined by additionally considering signal-data specifying information D25 (see FIGS. 3A to 3C) in addition to the procedure (iii).

(vi) Abnormality presence/absence is determined by additionally considering output data D31 (see FIGS. 4A to 4C) in addition to the procedure (i), (ii), (iii), (iv), or (v).

(vii) Abnormality presence/absence is determined by additionally considering output-timing specifying information D33 (see FIGS. 4A to 4C) in addition to the procedure (vi).

(viii) A determination result is stored, after determination is executed, along with information used in the determination, in addition to the any one of the procedures (i) to (vii).

Thus, according to the system of the embodiment, the monitor device 4 can determine abnormality between the signal device 1 and the computation device 2 even without grasping any contents themselves of a computation function of the computation device 2.

Furthermore, as shown in FIG. 3C, the data frame sent by the computation device 2 includes, along with the operation command data D21 indicating an operation command for the output device 3, the operation condition data D22 and operation trigger data D23 used in abnormality determination in the monitor device 4. The computation device 2 thereby only once sends this data frame without necessity of separately sending different data frames to either of the output device 3 or the monitor device 4. Otherwise, the computation device 2 must send data including the operation condition data D22 and the like to the monitor device 4 in addition to sending data including the operation data D21 to the output device 3.

(Modification)

Although the embodiment of the present invention is explained above, the present invention is not limited to the above embodiment, but also directed to various embodiments.

(i) In the door-lock system (see FIG. 1B), two operation triggers, a door-lock switch and a vehicle speed, are present, so that operation trigger data D23 shown in FIGS. 3A to 3B are necessary in the operation data. However, if the door-lock system is effected under only one condition that the door-lock switch shifts to an ON state, operation trigger is not necessary for being differentiated for determination. Namely, when only one operation trigger is present, the operation trigger is unnecessary.

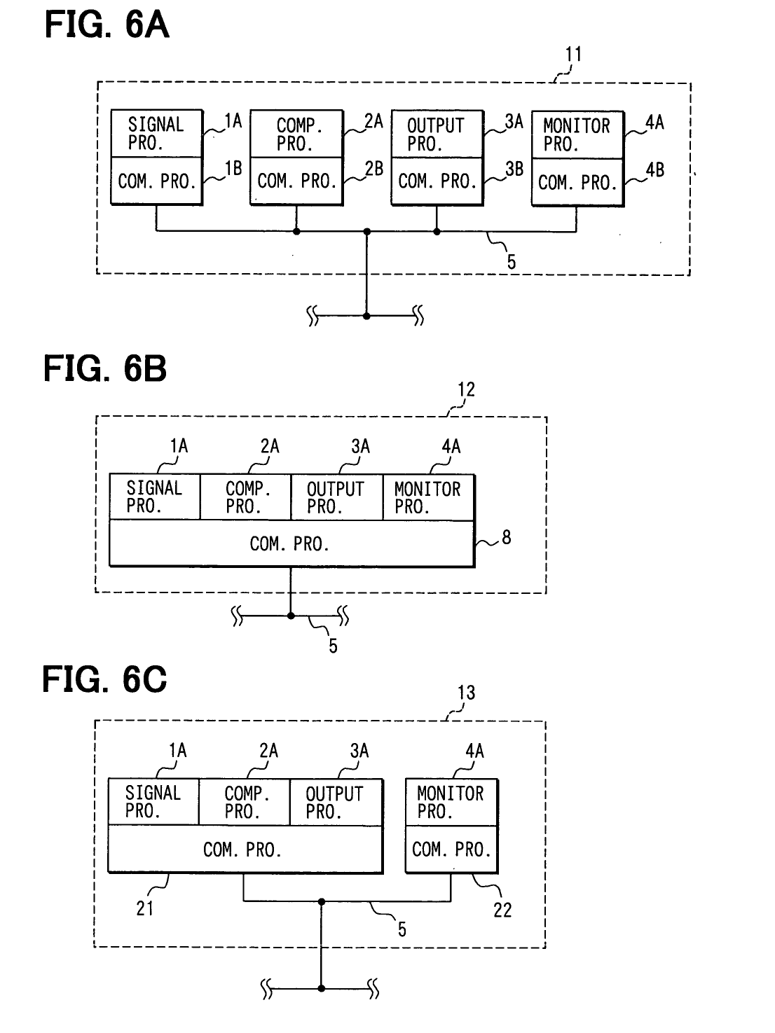

(ii) A signal device 1, a computation device 2, an output device 3, and a monitor device 4 are explained as independent devices. However, as shown in FIG. 6A, a single processing device 11 can include: a pair of a signal processing unit 1A and a communication processing unit 1B; a pair of a computation processing unit 2A and a communication processing unit 2B; a pair of an output processing unit 3A and a communication processing unit 3B; and a pair of a monitor processing 4A and a communication processing unit 4B. Here, within the processing device 11, each of the communication processing units 1B, 2B, 3B, 4B can be disposed as mutually communicating data through a communications bus 5.

In FIG. 6A, four communication processing units 1B, 2B, 3B, 4B are disposed for the signal processing unit 1A, the computation processing unit 2A, the output processing unit 3A, and the monitor processing unit 4A, respectively. However, as shown in FIG. 6B, a processing device 12 can include only one communication processing unit 8 commonly used for the signal processing unit 1A, the computation processing unit 2A, the output processing unit 3A, and the monitor processing unit 4A. Here, the signal processing unit 1A, the computation processing unit 2A, the output processing unit 3A, and the monitor processing unit 4A can mutually communicate data without any communications bus. In detail, a memory can be common for processing in the signal, computation, output, and monitor processing units 1A, 2A, 3A, 4A, e.g., by using a common RAM. Generating data frame in executing communication processing is naturally done by the communication processing unit 8. Even when a signal function, a computation function, and an output function are thus assembled in one device 12, the preceding functions are sometimes manufactured by the different manufactures, respectively. As a result, even within the one device 12, in which function abnormality is present must be determined, so that the present invention can be effectively directed to this device 12.

Further, as shown in FIG. 6C, a processing device 13 includes a set of a signal processing unit 1A, a computation processing unit 2A, an output processing unit 3A, and a communication processing unit 21 that is commonly used for the preceding units 1A, 2A, 3A. It further includes the other separated set of a monitor processing unit 4A and a communication processing unit 22. Here, the communication processing units 21, 22 communicate data through a communications bus 5 with each other. Any one or two of the signal processing unit 1A, the computation processing unit 2B, the output processing unit 3A, and the monitor processing unit 4A can be otherwise disposed as being separated from the other within one processing device.

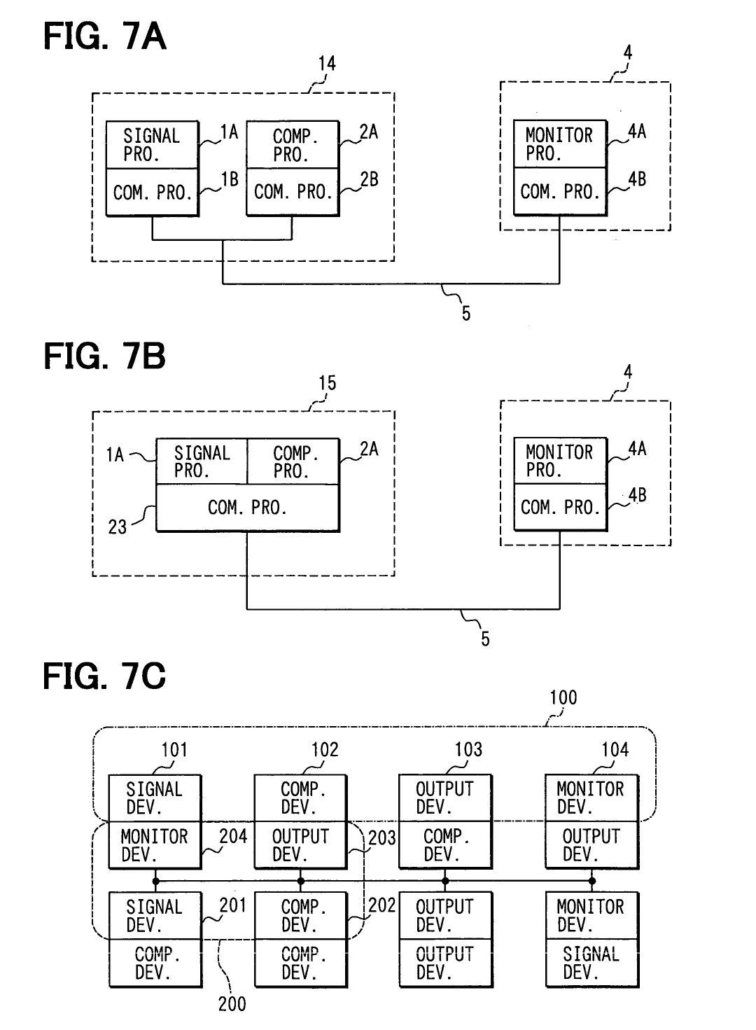

(iii) In FIGS. 6A to 6C, a signal processing unit 1A, a computation processing unit 2A, an output processing unit 3A, and a monitor processing unit 4A are included in any one of the processing devices 11, 12, 13. However, the units 1A, 2A, 3A, 4A are dividedly disposed in plural devices. For instance, in FIG. 7A, a monitor device 4 having a monitor processing unit 4A and a communication processing unit 4B is separated from the other processing device 14 having a pair of a signal processing unit 1A and a communication processing unit 1B and a pair of a computation processing unit 2A and a communication processing unit 2B. Here, a monitor processing unit 3A is not disposed within the processing unit 14. Thus, a control system can be designed as including no output processing unit or device or as including one or more output units or devices. In FIG. 7A, the communication processing units 1B, 2B within the processing device 14 communicate data through a communications bus 5 with each other and also with the communication processing unit 4B within the monitor device 4.

As shown in FIG. 7B, a processing device 15 can be designed as including a communication processing unit 23 that is commonly used for a signal processing unit 1A and a computation processing unit 2A.

(iv) In FIGS. 1A, 6A, 6B, 6C, 7A, 7B, an independent control system is explained. However, in practical usage, plural systems can be related as shown in FIG. 7C. Here, the first control system 100 includes a signal device 101, a computation device 102, an output device 103, and a monitor device 104. The second control device 200 includes a signal device 201, a computation device 202, an output device 203, and a monitor device 204. However, the signal device 101 of the first control system 100 is integrated with the monitor device 204 of the second control system 200, while the computation device 102 of the first control system 100 is integrated with the output device 203 of the second control system 200. Furthermore, other devices are also integrated with other devices of a different control system. It means that monitor function in a network system having one or more control systems can be provided not only as being alone and independent, but also as being integrated within another device for lowering cost. Furthermore, this structure enables a network system to easily have a plurality of monitor functions. This leads to enhancing reliability by disposing a plurality of monitor functions to the same control system. This also leads to dispersing load of each monitor function by dividing a plurality of monitor control system targets into a plurality of the monitor functions.

It will be obvious to those skilled in the art that various changes may be made in the above-described embodiments of the present invention. However, the scope of the present invention should be determined by the following claims.

What is claimed is:

1. A control system comprising:
a signal processing unit;
a computation processing unit; and
a monitor processing unit,
wherein the signal processing unit, the computation processing unit, and the monitor processing unit mutually communicate data,
wherein the signal processing unit sends, to the computation processing unit and the monitor processing unit, signal data that indicates at least one of a state of a switch and a detection result of a sensor,
wherein the computation processing unit executes a computation using at least one of the signal data sent by the signal processing unit, signal data sent by other than the signal processing unit, and internal data, and then sends operation command data to an output processing unit and operation condition data to the monitor processing unit, and wherein the operation command data controls the output processing unit for activating at least one of an actuator and a load, wherein the operation condition data indicates that condition where an operation command trigger that activates an operation command target is effected,
wherein the monitor processing unit receives the signal data sent by the signal processing unit and stores the received signal data, and
wherein the monitor processing unit determines whether abnormality is present, by comparing the stored signal data with the operation condition data received from the computation processing unit.

2. The control system according to claim 1,
wherein the operation command trigger is one of a plurality of operation command triggers,
wherein the computation processing unit sends, to the monitor processing unit along with the operation condition data, operation trigger data indicating the operation command trigger, and
wherein the monitor processing unit determines whether abnormality is present by additionally considering the operation command trigger received from the computation processing unit.

3. The control system according to claim 1,
wherein the signal processing unit sends, along with the signal data, timing information that specifies sending timing at which the signal data is sent,
wherein the monitor processing unit receives the timing information sent by the signal processing unit along with the signal data and stores the received timing information with correlating the timing information with the signal data, and
wherein the monitor processing unit determines whether abnormality is present by additionally considering the stored timing information.

4. The control system according to claim 3,
wherein the timing information includes at least one of a counter value, a random number that is not repeatedly used, and a time when sending is executed.

5. The control system according to claim 1,
wherein the computation processing unit generates a data frame that includes the operation command data for the output processing unit and the operation condition data for the monitor processing unit and sends the generated data frame to the output processing unit and the monitor processing unit.

6. The control system according to claim 1,
wherein, after the monitor processing unit determines whether abnormality is present, the monitor processing unit stores a result of determination along with information that is used for the determination.
